(19) United States
(12) Patent Application Publication
(10) Pub. No.: US 2024/0245037 A1
(43) Pub. Date: Jul. 25, 2024

(54) MULTI-USE MONITORING SYSTEM

(71) Applicant: CALYX, INC., Berkeley, CA (US)

(72) Inventors: Po-Jui CHIU, Taipei City (TW); Benson FAN, Taipei City (TW); Ming-Yuan TSAI, Taipei City (TW); I-Ting CHEN, Taipei City (TW); Chia-Cheng LIAO, Taichung City (TW); Shin-Kai MA, Taipei City (TW); Tsung-Lin LU, Taichung City (TW); Chan-Hsin YEH, New Taipei City (TW); To-An TING, Kaohsiung City (TW); Ting-Shuo CHANG, Taipei City (TW)

(73) Assignee: CALYX, INC., Berkeley, CA (US)

(21) Appl. No.: 18/418,832

(22) Filed: Jan. 22, 2024

Related U.S. Application Data
(60) Provisional application No. 63/440,113, filed on Jan. 20, 2023.

(51) Int. Cl. A01K 29/00; G06T 7/00; H04N 7/18

(52) U.S. Cl. CPC A01K 29/005; G06T 7/0004; H04N 7/181; G06T 2207/30232

(57) ABSTRACT

A multi-use monitoring system is disclosed, which comprises an electronic device, multiple sensor devices, multiple cameras, at least one wireless interface, and a remote electronic device. According to the present invention, the sensor devices are adopted for detecting multiple environmental parameters such as gas level, humidity and temperature, and the multiple cameras are controlled to acquire images from the poultry bred in a breeding environment. Therefore, after receiving the images and the environmental parameters from the electronic device, the remote electronic device can extract at least one poultry characteristic from the images, and then correlate the environmental parameters to the poultry characteristic(s). As a result, the remote electronic device can subsequently calculate an evaluation score according to the growth and/or health state of the poultry, such that the breeder can plan how to distribute the breeding resources for the poultry.

### BACKGROUND OF THE INVENTION

### 1. Field of the Invention

The present invention relates to the technology field of environmental monitoring, and more particularly to a multi-use monitoring system.

### 2. Description of the Prior Art

Chicken is the most consumed meat in the world, and is continuously growing. With ever larger demand, control over every aspect of chicken meat production becomes paramount. In addition, as consumers become increasingly aware of food supply, demand for sustainably raised chicken, as well as welfare of chicken gained increased importance. Accordingly, how to carry out an effective breeding environment monitoring and control has become an important and ignorable issue.

According to the existing research report, abnormal concentration of certain gases, including ammonia, carbon dioxide, carbon monoxide, and odor gas, would lead the chickens to be suffered from respiratory diseases in case of the level thereof being too high. Moreover, research report also indicates that anything above 29 degrees Celsius is hot for a chicken, and can lead the chickens to be weight decrease and suffered from heatstroke. On the other hand, research report further indicates that aspergillosis is a fungal infection generally affecting the respiratory system of a chicken. As explained in more detail below, Aspergillus spores survive and grow on organic matters like egg yolk, cardboard boxes and wood, and cycles of high and low humidity optimise the growth of the fungus (mycelium) and the spread of its spores.

According to above descriptions, it is understood that environmental parameters certainly affect the growth of broilers and hens (i.e., poultry). However, there is still a lack of environmental monitoring system capable of simultaneously conducting measurement of environmental parameter, measurement of poultry characteristic(s) and correlation between environmental parameters and poultry characteristic(s). In view of this fact, inventors of the present application have made great efforts to make inventive research and eventually provided a multi-use monitoring system. As such, a system that can combine environmental and growth performance data can attain the goal of predictive livestock monitoring.

### SUMMARY OF THE INVENTION

The primary objective of the present invention is to disclose a multi-use monitoring system, which comprises an electronic device, multiple sensor devices, multiple cameras, at least one wireless interface, and a remote electronic device. According to the present invention, the sensor devices are adopted for detecting multiple environmental parameters such as gas level, humidity and temperature, and the multiple cameras are controlled to acquire images from the poultry bred in a breeding environment. Therefore, after receiving the images and the environmental parameters from the electronic device, the remote electronic device can extract at least one poultry characteristic from the images, and then correlate the environmental parameters to the poultry characteristic. As a result, the remote electronic device can subsequently calculate an evaluation score according to the growth and/or health state of the poultry, such that the breeder can plan how to distribute the breeding resources for the poultry.

For achieving the primary objective mentioned above, the present invention provides an embodiment of the multi-use monitoring system, comprises:
an electronic device;
a plurality of cameras, being coupled to the electronic device;
a plurality of sensor devices, being coupled to the electronic device;
at least one wireless interface, being in communication with the electronic device; and
a remote electronic device, being in communication with the electronic device;
wherein the electronic device comprises a first processor and a first memory coupled to the first processor, the first memory storing a first application program, and the first processor executing the first application program so as to be configured to:
detect, by controlling the plurality of sensor devices, a plurality of environmental parameters of a breeding environment;
acquire, by controlling the plurality of cameras, a plurality of images of a group of poultry animals bred in the breeding environment; and
transmit, by controlling the wireless interface, the plurality of images and the plurality of environmental parameters to the remote electronic device;
wherein the remote electronic device comprises a second processor and a second memory coupled to the second processor, the second memory storing a second application program, and the second processor executing the second application program so as to be configured to:
extract, after applying at least one image process to at least one said image, at least one poultry characteristic and at least one environmental feature from the plurality of images; and
correlate, at least one said environmental parameter and/or at least one environmental feature to the at least one poultry characteristic.

In one embodiment, each said sensor device has a plug and play interface, and the first processor executes the first application program so as to be further configured to:
recognize and then enable, after a sensor component is integrated in said sensor device thereby being electrically connected to the plug and play interfaces, said sensor component.

In one embodiment, the environmental parameter is selected from a group consisting of gas level, wind speed, temperature, humidity, and particulate matter (PM).

In one embodiment, the poultry animal is selected from a group consisting of chicken, duck and goose.

In one embodiment, the sensor component is integrated with at least one sensor film for sensing specific gas selected from a group consisting of ammonia (NH₃), carbon dioxide (CO₂), methane (CH₄), carbon monoxide (CO), molecular oxygen (O₂), ozone (O₃), nitric oxide (NO), nitric dioxide (NO₂), sulfur dioxide (SO₂), hydrogen sulfide (H₂S), and formaldehyde (CH₂O).

In one embodiment, each said camera is integrated with a storage device therein, and the storage device is selected from a group consisting of flash memory and solid-state drive (SSD) card.

In one embodiment, the electronic device is integrated with a storage device therein, and the storage device is selected from a group consisting of hard disk drive (HDD), flash memory and solid-state drive (SSD) card.

In one embodiment, each said camera is powered by a battery device, a power adapter or a PoE device, and being selected from a group consisting of SWIR camera, MWIR camera, LWIR camera, RGB camera, RGB-IR camera, LiDAR camera, time-of-flight (ToF) camera, and structured light camera.

In one embodiment, the second processor executes the second application program so as to be further configured to:
identify and outline, a plurality of individual poultry animal profiles corresponding to the group of poultry animals appearing in said image;
generate, after processing the plurality of images, a thermal profile of the group of poultry animals appearing in said image;
recognize, any one object that is not said poultry animal contained in said image;
predict, based on the plurality of individual poultry animal profiles, a weight of each said poultry animal;
calculate, based on a weight data consisting of the weight of each said poultry animal, a uniformity of the group of poultry animals bred in the breeding environment; and
predict, a weight increase of each said poultry animal.

In one embodiment, the plurality of images comprise 2D images, 3D images, and thermal images.

In one embodiment, the environmental feature is selected from a group consisting of litter temperature, litter water content, activity of said poultry animal, and acoustic profile of said poultry animal.

In one embodiment, the wireless interface is selected from a group consisting of 4G communication interface, 4G LTE communication interface, 5G communication interface, 6G communication interface, WiFi interface, and Bluetooth interface.

In a practicable embodiment, the multi-use monitoring system according to the present invention further comprises:
at least one microphone, being coupled to the electronic device;
a plurality of peripheral devices, being coupled to the electronic device; and
a supporting module, wherein the electronic device is disposed on the supporting member, has a mount member for ceiling mounting and/or a din rail adapter for being attached on a din rail.

In one embodiment, the peripheral device is selected from a group consisting of lighting device, gyroscope, and warning device.

In one embodiment, the first processor executes the first application program so as to be further configured to:
activate, by controlling said warning device, an alarm in case of said environmental parameter being greater than an upper limit value and/or being less than a lower limit value.

### BRIEF DESCRIPTION OF THE DRAWINGS

The invention as well as a preferred mode of use and advantages thereof will be best understood by referring to the following detailed description of an illustrative embodiment in conjunction with the accompanying drawings, wherein:

FIG. 1 is a schematic stereo diagram of a multi-use monitoring system according to the present invention;

FIG. 2 is a block diagram of the multi-use monitoring system according to the present invention;

FIG. 3 is a block diagram of an electronic device shown in FIG. 1; and

FIG. 4 is a block diagram of a remote electronic device shown in FIG. 1.

### DETAILED DESCRIPTION OF THE PREFERRED EMBODIMENTS

To more clearly describe a multi-use monitoring system according to the present invention, embodiments of the present invention will be described in detail with reference to the attached drawings hereinafter.

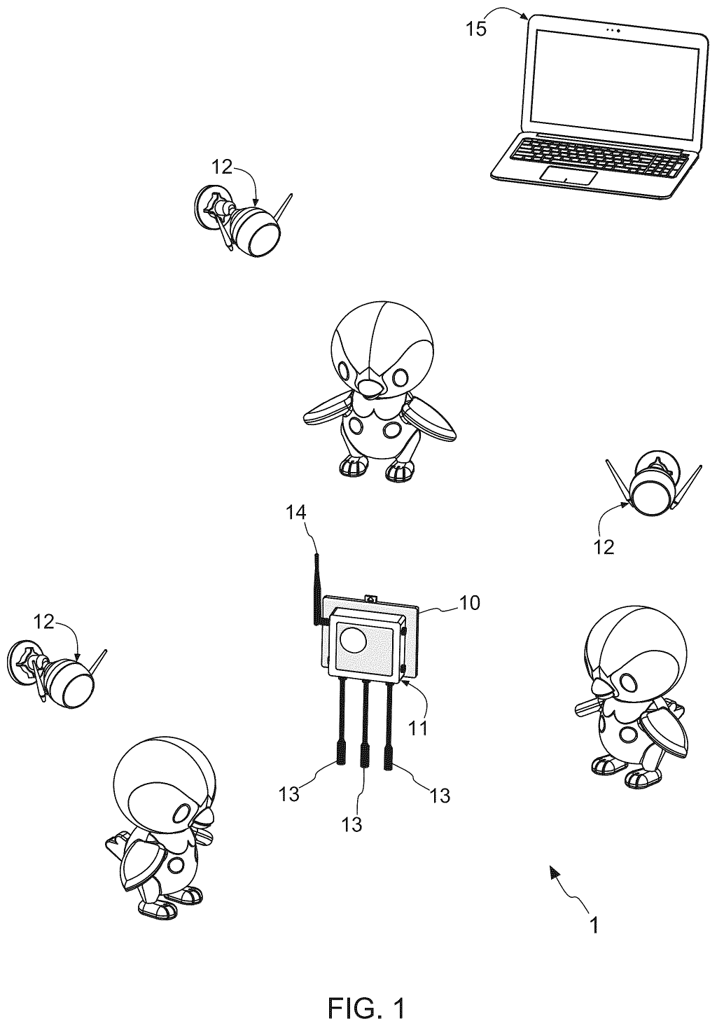

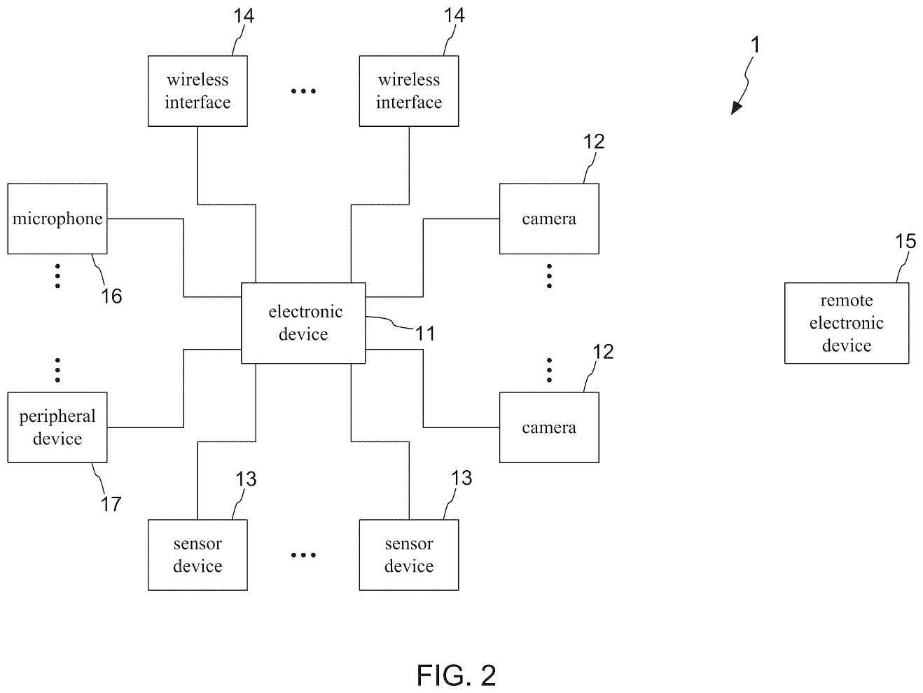

FIG. 1 illustrates a schematic stereo diagram of a multi-use monitoring system according to the present invention. Moreover, FIG. 2 is a block diagram of the multi-use monitoring system. According to FIG. 1 and FIG. 2, the multi-use monitoring system 1 principally comprises an electronic device 11, a plurality of cameras 12, a plurality of sensor devices 13, at least one wireless interface 14, and a remote electronic device 15, in which the electronic device 11 is disposed on a supporting member 10, and the supporting member 10 has a mount member 101 for ceiling mounting, a din rail adapter for being attached on a din rail and/or a wall mount. Electronic device 11 can be separate between the camera 12 and the sensor devices 13. The electronic device 11 that analyzes the data of camera 12 and the sensor devices 13 as two separate devices.

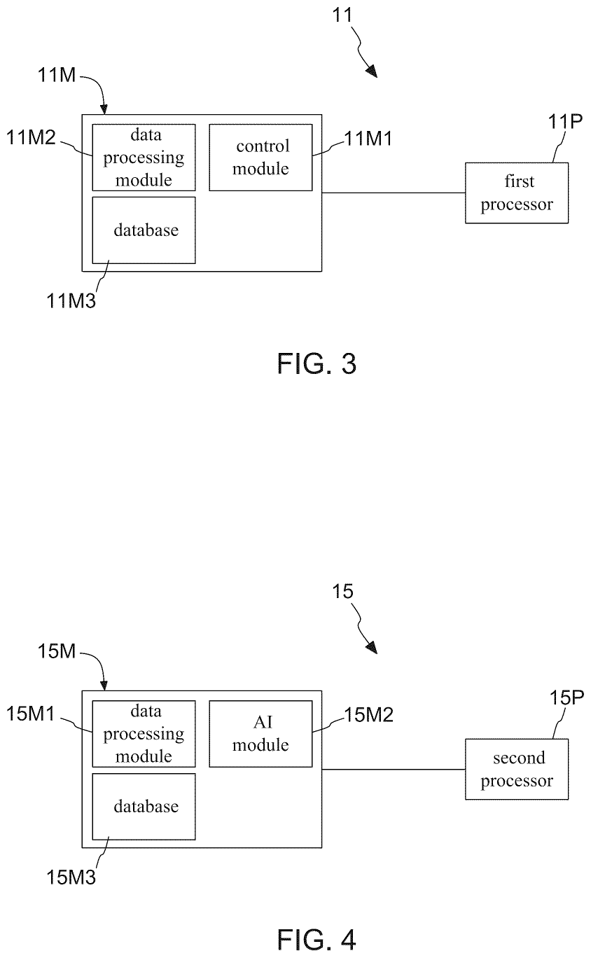

FIG. 2 illustrate is a block diagram of the electronic device shown in FIG. 1. According to FIG. 1, FIG. 2 and FIG. 3, the plurality of cameras 12 and the plurality of sensor devices 13 are coupled to the electronic device 11, and the at least one wireless interface 14 is in communication with the electronic device 11. As described in more detail below, the electronic device 11 comprises a first processor 11P and a first memory 11M coupled to the first processor 11P, wherein the first memory 11P stores a first application program, such that the first processor 11P is configured to perform functions after executing the first application program. In one embodiment, the first application program comprises a control module 11M1 and a data processing module 11M2, and the first memory 11M further provided with a database 11M3 therein.

The plurality of sensor devices 13 are adopted for detecting and collecting a plurality of environmental parameters of a poultry environment. According to the present invention, each said sensor device 13 has a plug and play interface, and the first processor 11P executes the first application program thereby being configured to: recognize and then enable, after a sensor component is integrated in said sensor device 13 thereby being electrically connected to the plug and play interfaces, said sensor component. In one embodiment, the sensor component is integrated with at least one sensor film for sensing specific gas, and said specific gas can be, but is not limited to, ammonia (NH₃), carbon dioxide (CO₂), methane (CH₄), carbon monoxide (CO), molecular oxygen (O₂), ozone (O₃), nitric oxide (NO), nitric dioxide (NO₂), sulfur dioxide (SO₂), hydrogen sulfide (H₂S), and/or formaldehyde (CH₂O). Briefly speaking, the sensor component is adopted for sensing the gas level of at least one of the aforesaid gases. Moreover, said sensor device 13 can also be integrated with a temperature sensor, a humidity sensor, and/or particulate matter (PM) sensor therein. As further explained in more detail below, each said sensor device 13 can be replaced by a different one while the system 1 is operating, and the system 1 would automatically take the reading from the new sensor device 13, recognizing the type of the sensor component, and output the sensor reading from the new sensor device 13.

On the other hand, the plurality of cameras 12 are adopted for acquiring a plurality of images of a group of poultry animals bred in the breeding environment, wherein each said camera 12 can be integrated with a storage device therein, like flash memory or solid-state drive (SSD) card. Moreover, in a practicable embodiment, the poultry animal can be, but is not limited to, chicken, duck or goose. In addition, said camera 12 is powered by a battery device, a power adapter or a PoE device, and can be, but is not limited to, SWIR camera, MWIR camera, LWIR camera, RGB camera, RGB-IR camera, LiDAR camera, time-of-flight (ToF) camera, or structured light camera. Correspondingly, the aforesaid images may include 2D images, 3D images, and thermal images. And camera could also be connected with an automated weighing scale to measure poultry weight to directly correlate camera data with the scale weight data.

FIG. 4 illustrate a block diagram of a remote electronic device shown in FIG. 1. According to FIG. 1, FIG. 2 and FIG. 4, the remote electronic device 15 is in communication with the electronic device 11, and comprises a second processor 15P and a second memory 15M coupled to the second processor 15P, wherein the second memory 15P stores a second application program, such that the second processor 15P is configured to perform at least one function after executing the second application program. In one embodiment, the second application program comprises a data processing module 15M1 and an AI module 15M2, and the second memory is further provided with a database 15M3 therein. On the other hand, the remote electronic device 15 could be a cloud system, used for computation and data collection. Sensor devices 13 have on-board processing capability for sensor data, can transmit data wirelessly to the remote electronic device 15 (cloud), and the results are displayed. As such, camera data does not go through the sensor devices 13.

Camera mostly directly transmit image data through ethernet (PoE) to the cloud, and is processed there

[symbol]

When the multi-use monitoring system 1 is disposed in a poultry farm environment for monitoring various parameters of the breeding environment as well as growth variations of a group of poultry animals bred in the breeding environment, the first electronic device 11P executes the control module 11M1, thereby being configured to:
detect, by controlling the plurality of sensor devices 13, a plurality of environmental parameters of a breeding environment;
acquire, by controlling the plurality of cameras 12, a plurality of images of a group of poultry animals bred in the breeding environment; and
transmit, by controlling the wireless interface 14, the plurality of images and the plurality of environmental parameters to the remote electronic device 15.

In a practicable embodiment, the wireless interface 14 can be, but is not limited to, 4G communication interface, 4G LTE communication interface, 5G communication interface, 6G communication interface, WiFi interface, or Bluetooth interface. Moreover, the environmental parameters comprises gas level, wind speed, temperature, humidity, and particulate matter (PM), and the plurality of images comprise 2D images, 3D images, and thermal images. Therefore, the electronic device 11 can be further integrated with a storage device for storing a data of the environmental parameters and the images of the poultry animals, and the storage device comprise a hard disk drive (HDD), a flash memory and/or a solid-state drive (SSD) card.

FIG. 1 and FIG. 2 also depict that the multi-use monitoring system 1 further comprises at least one microphone 16 and plurality of peripheral devices 17, and the microphone 16 and the peripheral devices 17 are all coupled to the electronic device 11. Moreover, in one embodiment, the peripheral devices comprise at least one of lighting device, gyroscope, and/or warning device. Correspondingly, the first processor 11P executes the first application program so as to be further configured to: activate, by controlling said warning device, an alarm in case of said environmental parameter being greater than an upper limit value and/or being less than a lower limit value.

After receiving the environmental parameters and the images of the poultry animals from the electronic device 11, the second processor 15P executes the data processing module 15M1 and the AI module 15M2, thereby being configured to:
extract, after applying at least one image process to at least one said image, at least one poultry characteristic and at least one environmental feature from the plurality of images; and
correlate, at least one said environmental parameter and/or at least one environmental feature to the at least one poultry characteristic.

In one embodiment, the environmental feature comprises at least one of litter temperature, litter water content, activity of said poultry animal, and acoustic profile of said poultry animal. Therefore, after conducting measurement of the environmental parameters, extraction of the poultry characteristic(s), extraction of environmental feature(s), and correlation between the environmental parameters and/or the environmental feature(s) to the poultry characteristic(s), the second processor 15P is subsequently configured to calculate an evaluation score for showing a growth state and/or a health state of said poultry animal, such that the breeder can plan how to distribute the breeding resources for the group of poultry animals.

Particularly, the AI module 15M2 comprises a pre-trained growth prediction model and a pre-trained recognition model, such that the second processor 15P executes the AI module 15M2 so as to be further configured to:
identify and outline, a plurality of individual poultry animal profiles corresponding to the group of poultry animals appearing in said image;
generate, after processing the plurality of images, a thermal profile of the group of poultry animals appearing in said image;
recognize, any one object that is not said poultry animal contained in said image;
predict, based on the plurality of individual poultry animal profiles, a weight of each said poultry animal;
calculate, based on a weight data consisting of the weight of each said poultry animal, a uniformity of the group of poultry animals bred in the breeding environment; and
predict, a weight increase of each said poultry animal.

### Example 1

Minimum ventilation is often utilized in poultry houses (i.e., the breeding environment) during cold climate to save heating cost, but can lead to worsening environmental conditions. In such application environment, the multi-use monitoring system 1 collects environmental parameter including temperature, relative humidity, ammonia, CO₂, and litter moisture level, and also acquires images of the poultry animals bred in the poultry houses. After obtaining the poultry characteristics including weight, daily weight gain, uniformity and mortality, and the remote electronic device 15 is able to correlate the poultry characteristic(s) to the environmental parameter(s). If there is a correlation between poultry characteristic(s) and the environmental parameter(s) during minimum ventilation, the remote electronic device 15 would continuously generate a ventilation adjusting suggestion for properly changing environmental parameters.

### Example 2

In another example, the effectiveness of litter treatment can be evaluated by using this multi-use monitoring system 1. After the breeder applies one or more different litter treatments to the poultry houses (i.e., breeding environment), the system 1 is operated for collecting the environments parameter and detecting the growth data of the poultry animals bred in the breeding environment. As a result, after conducting the measurement of environmental parameters, the measurement of poultry characteristic(s) and correlation between environmental parameters and poultry characteristic(s), the remote electronic device 15 succeeds in correlating the poultry characteristic(s) to the environmental parameter(s). If there is a correlation between poultry characteristic(s) and the environmental parameter(s) during minimum ventilation, the remote electronic device 15 would continuously generate a litter treatment adjusting suggestion for properly changing environmental parameters.

Therefore, through above descriptions, all embodiments and their constituting elements of the multi-use monitoring system according to the present invention have been introduced completely and clearly. Moreover, the above description is made on embodiments of the present invention. However, the embodiments are not intended to limit the scope of the present invention, and all equivalent implementations or alterations within the spirit of the present invention still fall within the scope of the present invention.

What is claimed is:

1. A multi-use monitoring system, comprising:
an electronic device;
a plurality of cameras, being coupled to the electronic device;
a plurality of sensor devices, being coupled to the electronic device;
at least one wireless interface, being in communication with the electronic device; and
a remote electronic device, being in communication with the electronic device;
wherein the electronic device comprises a first processor and a first memory coupled to the first processor, the first memory storing a first application program, and the first processor executing the first application program so as to be configured to:
detect, by controlling the plurality of sensor devices, a plurality of environmental parameters of a poultry farm environment;
acquire, by controlling the plurality of cameras, a plurality of images of a group of poultry animals bred in the poultry farm environment; and
transmit, by controlling the wireless interface, the plurality of images and the plurality of environmental parameters to the remote electronic device;
wherein the remote electronic device comprises a second processor and a second memory coupled to the second processor, the second memory storing a second application program, and the second processor executing the second application program so as to be configured to:
extract, after applying at least one image process to at least one said image, at least one poultry characteristic and at least one environmental feature from the plurality of images; and
correlate, at least one said environmental parameter and/or at least one environmental feature to the at least one poultry characteristic.

2. The multi-use monitoring system of claim 1, wherein each said sensor device has a plug and play interface, and the first processor executing the first application program so as to be further configured to:
recognize and then enable, after a sensor component is integrated in said sensor device thereby being electrically connected to the plug and play interfaces, said sensor component.

3. The multi-use monitoring system of claim 1, wherein the environmental parameter is selected from a group consisting of gas level, wind speed, temperature, humidity, and particulate matter (PM).

4. The multi-use monitoring system of claim 1, wherein the poultry animal is selected from a group consisting of chicken, duck and goose.

5. The multi-use monitoring system of claim 2, wherein the sensor component is integrated with at least one sensor film for sensing specific gas selected from a group consisting of ammonia (NH₃), carbon dioxide (CO₂), methane (CH₄), carbon monoxide (CO), molecular oxygen (O₂), ozone (O₃), nitric oxide (NO), nitric dioxide (NO₂), sulfur dioxide (SO₂), hydrogen sulfide (H₂S), and formaldehyde (CH₂O).

6. The multi-use monitoring system of claim 1, wherein each said camera is integrated with a storage device therein, and the storage device is selected from a group consisting of flash memory and solid-state drive (SSD) card.

7. The multi-use monitoring system of claim 1, wherein the electronic device is integrated with a storage device therein, and the storage device is selected from a group consisting of hard disk drive (HDD), flash memory and solid-state drive (SSD) card.

8. The multi-use monitoring system of claim 1, wherein each said camera is powered by a battery device, a power adapter or a PoE device, and being selected from a group consisting of SWIR camera, MWIR camera, LWIR camera, RGB camera, RGB-IR camera, LiDAR camera, time-of-flight (ToF) camera, and structured light camera.

9. The multi-use monitoring system of claim 8, wherein the second processor executes the second application program so as to be further configured to:
identify and outline, a plurality of individual poultry animal profiles corresponding to the group of poultry animals appearing in said image;
generate, after processing the plurality of images, a thermal profile of the group of poultry animals appearing in said image;
recognize, any one object that is not said poultry animal contained in said image;
predict, based on the plurality of individual poultry animal profiles, a weight of each said poultry animal;
calculate, based on a weight data consisting of the weight of each said poultry animal, a uniformity of the group of poultry animals bred in the breeding environment; and
predict, a weight increase of each said poultry animal.

10. The multi-use monitoring system of claim 8, wherein the plurality of images comprise 2D images, 3D images, and thermal images.

11. The multi-use monitoring system of claim 8, wherein the environmental feature is selected from a group consisting of litter temperature, litter water content, activity of said poultry animal, and acoustic profile of said poultry animal.

12. The multi-use monitoring system of claim 1, wherein the wireless interface is selected from a group consisting of 4G communication interface, 4G LTE communication interface, 5G communication interface, 6G communication interface, WiFi interface, and Bluetooth interface.

13. The multi-use monitoring system of claim 1, further comprising:
at least one microphone, being coupled to the electronic device;
a plurality of peripheral devices, being coupled to the electronic device; and
a supporting module, wherein the electronic device is disposed on the supporting member, has a mount member for ceiling mounting, a din rail adapter for being attached on a din rail and/or a wall mount.

14. The multi-use monitoring system of claim 13, wherein the peripheral device is selected from a group consisting of lighting device, gyroscope, and warning device.

15. The multi-use monitoring system of claim 1, wherein each said camera is connected with an automated weighing scale.
